(19) United States
(12) Patent Application Publication
(10) Pub. No.: US 2007/0265864 A1
(43) Pub. Date: Nov. 15, 2007

(54) System and method for measuring business transformation impact using social network analytics

(75) Inventors: Catherine Anne Chess, Ossining, NY (US); Kate Ehrlich, Newton, MA (US); Mary Elizabeth Helander, North White Plains, NY (US); Catherine Carroll Lasser, Brookfield, CT (US); Sue Ann Medeiros, Hartsdale, NY (US); Katherine Penchuk, New York, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/414,233

(22) Filed: May 1, 2006

(51) Int. Cl. G06Q 10/00; G06Q 30/00

(52) U.S. Cl. 705/1

(57) ABSTRACT

A system and method (and method of deploying computing infrastructure) of a system, method, and framework for measuring the impact of a collaborative activity, or set of activities, based on social networks and attributes observed before and after the collaborative activity.

### CROSS-REFERENCE TO RELATED APPLICATION

The present application is related to U.S. patent application Ser. No. 11/______, filed on May 1, 2006, to Chess, et al., entitled “SYSTEM AND METHOD FOR CONSTRUCTING A SOCIAL NETWORK FROM MULTIPLE, DISPARATE, HETEROGENEOUS DATA SOURCES” having IBM Docket No. YOR920060237US1, which is incorporated herein by reference, in its entirety.

### BACKGROUND OF THE INVENTION

1. Field of the Invention

The present invention generally relates to a system and method for measuring the impact of a collaborative activity (e.g., transformational activity, or business transformational activity), or set of activities, and more particularly, to a system, method, and framework for measuring impact of a collaborative activity using social network analytics.

2. Description of the Related Art

For purposes of the present application, the term “social network” generally means a social structure made of nodes which are generally individuals or organizations, and edges or links between them.

For purposes of the present application, the term “social computing”, or social network technology, generally means the use of social software. Social computing represents a growing trend of tools supporting social interaction and communication. For example, social computing can include email, instant messaging, blogs, wikis, auctions, web interactive communication or research, online social networking websites, etc.

A social network is a map of the relationships between individuals, indicating the ways in which they are connected through various social familiarities ranging from casual acquaintance to close familial bonds. The term was first coined in 1954 by J. A. Barnes (in: Class and Committees in a Norwegian Island Parish, “Human Relations”). Social network analysis (SNA) (also sometimes called network theory) has emerged as a key technique in modern sociology, anthropology, social psychology and organizational studies.

Research in a number of academic fields has demonstrated that social networks operate on many levels, from families up to the level of nations, and play a critical role in determining the way problems are solved, organizations are run, information is shared, and the degree to which individuals succeed in achieving their goals.

Social networking also refers to a category of Internet applications to help connect friends, business partners, or other individuals together using a variety of tools. These applications, known as online social networks are becoming increasingly popular.

Generally, social network theory views social relationships in terms of nodes and ties (or ties). Nodes are the individual actors within the networks, and linkages are the relationships between the actors.

There can be many kinds of linkages between the nodes. In its most simple form, a social network is a map of all of the relevant linkages between the nodes being studied. The network can also be used to determine the social capital of individual actors. These concepts are often displayed in a social network diagram, where nodes are the points and linkages are the lines.

The shape of the social network helps determine a network's usefulness to its individuals. Smaller, tighter networks can be less useful to their members than networks with lots of loose connections (weak ties) to individuals outside the main network. More “open” networks, with many weak ties and social connections, are more likely to introduce new ideas and opportunities to their members than closed networks with many redundant ties. In other words, a group of friends who only do things with each other already share the same knowledge and opportunities. A group of individuals with connections to other social worlds is likely to have access to a wider range of information. It is better for individual success to have connections to a variety of networks rather than many connections within a single network. Similarly, individuals can exercise influence or act as brokers within their social networks by bridging two networks that are not directly linked (called filling social holes).

The power of social network theory stems from its difference from traditional sociological studies, which assume that it is the attributes of individual actors that matter. Social network theory produces an alternate view, where the attributes of individuals are less important than their relationships and ties with other actors within the network. This approach has turned out to be useful for explaining many real-world phenomena, but leaves less room for individual agency, and the ability for individuals to influence their success, since so much of it rests within the structure of their network.

Social networks have also been used to examine how companies interact with each other, characterizing the many informal connections that link executives together, as well as associations and connections between individual employees at different companies. These networks provide ways for companies to gather information, deter competition, and even collude in setting prices or policies.

Power within organizations, for example, generally has been found to come more from the degree to which an individual within a network is at the center of many relationships than actual job title. Social networks also play a key role in hiring, in business success for firms, and in job performance.

Social networking websites (e.g., online social networks) have become widely used in virtual communities. In these communities, an initial set of founders sends out messages inviting members of their own personal networks to join the site. New members repeat the process, growing the total number of members and links in the network. Sites then offer features such as automatic address book updates, viewable profiles, the ability to form new links through “introduction services,” and other forms of online social connections. Social networks can also be organized around business connections.

Blended networking is an approach to social networking that combines both offline elements (face-to-face events) and online elements. The newest social networks on the Internet are becoming more focused on niches.

### SUMMARY OF THE INVENTION

In view of the foregoing and other exemplary problems, drawbacks, and disadvantages of the related art methods and structures, an exemplary feature of the present invention is to provide a system, method, and framework for measuring the impact of a collaborative activity (or set of activities), such as a transformational activity, based on social networks and attributes observed before and after the collaborative activity (or set of activities).

More particularly, an exemplary feature of the present invention is to provide a system, method, and framework for predicting an “expectation” or “goal” (e.g., an expected state or goal state) for the effect of a collaborative activity.

More particularly, an exemplary feature of the present invention is to provide a system, method, and framework for measuring the impact of a set of transformational activities based on social networks and attributes observed before and after the transformational activities, as well as the “expected” or “goal” state.

The present invention recognizes that all collaborative activities, such as business transformations, impact people and communications patterns, both planned and unplanned. The exemplary aspects of the present invention provide improved, systematic change management.

The present invention recognizes that the capture of collaborative or transformational impact related to networks of people solves an important problem in value monitoring and attribution related to professional services delivery in a variety of fields and applications.

The exemplary aspects of the present invention can provide value for companies, organizations, groups, departments, etc., for example, by maximizing the benefit of transformational activities involving collaboration, as well as by enhancing consulting services offerings, etc.

In one exemplary aspect of the invention, a computer implemented method of measuring an impact of at least one collaborative activity, including comparing social networks and attributes observed before and after said at least one collaborative activity.

In another exemplary aspect of the invention, a system for measuring an impact of at least one collaborative activity, includes a comparing unit that compares social networks and attributes observed before and after said at least one collaborative activity.

In yet another exemplary aspect of the invention, a system for measuring an impact of at least one collaborative activity, includes means for constructing social networks and attributes observed before and after said at least one collaborative activity; and means for comparing social networks and attributes observed before and after said at least one collaborative activity.

Another exemplary system can include means for predicting an expected state for an effect of said at least one collaborative activity, wherein said means for comparing compares said social networks and attributes observed before and after said at least one collaborative activity and said expected state, and means for providing at least one of transformational guidance and course correction based on said comparing.

Another yet exemplary system can include means for at least one of performing a course correction for a next stage, predicting a next stage, and evaluating an effect of said at least one collaborative activity.

In another exemplary aspect of the invention, a method of deploying computing infrastructure in which recordable, computer-readable code is integrated into a computing system, and combines with the computing system to perform a method of measuring an impact of at least one collaborative activity, includes comparing social networks and attributes observed before and after said at least one collaborative activity.

In another exemplary aspect of the invention, a signal-bearing medium tangibly embodying a program of recordable, machine-readable instructions executable by a digital processing apparatus to perform and method of measuring an impact of at least one collaborative activity, includes comparing social networks and attributes observed before and after said at least one collaborative activity.

Conventional methods use SNA in before and after comparison to verify a hypothesis (e.g. xxx policy related to homeless individuals will result in a reduction of 10% of the homeless population in city y) as opposed to course guidance/correction/evaluation/verification in a business transformation/change management sense.

Other conventional methods use social network analysis as a way to measure in an observation mode, as opposed to transformational guidance, while others use before and after SNA studies to assess differences in social support and closeness in relationships, or to quantify change, not to guide transformation. Other conventional methods provide observational use of SNA, measurement use of SNA, and diagnosis and design suggestions, instead of for transformational guidance, according to the exemplary aspects of the present invention.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary method 100 according to an exemplary, non-limiting embodiment of the present invention;

FIG. 2 illustrates an exemplary method 200 according to another exemplary, non-limiting embodiment of the present invention;

FIG. 3 illustrates an exemplary system 300 according to an exemplary aspect of the invention;

FIG. 4 illustrates an exemplary system 400 according to an exemplary aspect of the invention;

FIG. 5 illustrates an exemplary system 500 according to an exemplary aspect of the invention;

FIG. 6 graphically illustrates an exemplary system 600 according to an exemplary aspect of the invention;

FIG. 7 graphically illustrates an exemplary system 700 according to an exemplary aspect of the invention;

FIG. 8 graphically illustrates an exemplary system 800 according to an exemplary aspect of the invention;

FIG. 9 illustrates an exemplary hardware/information handling system 900 for incorporating the present invention therein; and

FIG. 10 illustrates a signal bearing medium (e.g., storage medium 1000) for storing/recording steps of a program of a method according to the present invention.

### DETAILED DESCRIPTION OF EXEMPLARY EMBODIMENTS OF THE INVENTION

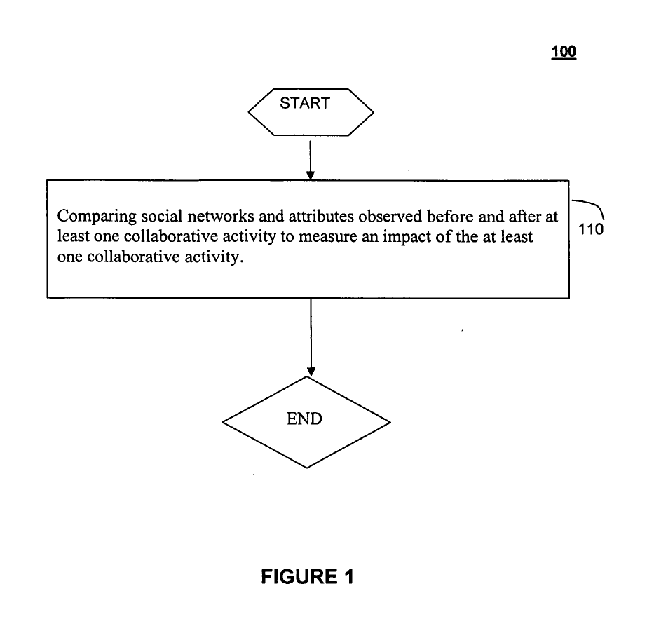

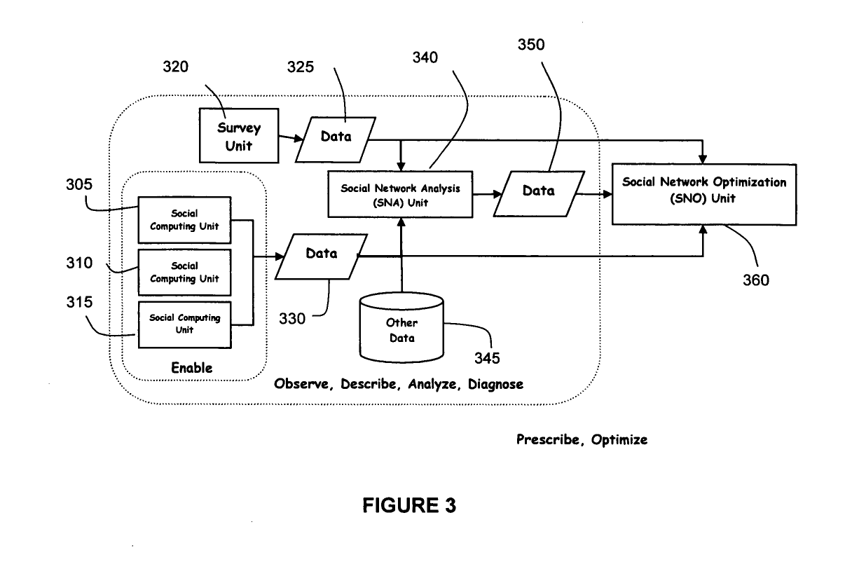

Referring now to the drawings, and more particularly to FIGS. 1-10, there are shown exemplary embodiments of the method and structures according to the present invention.

The present invention relates to a method and system for measuring impact of a collaborative activity, such as a business transformational activity, using social network analytics.

The present invention can provide a system, method, and framework for measuring the impact of a set of collaborative activities or transformational activities (e.g., business transformational activities, etc.) based on social networks and attributes observed before and after the collaborative activities. More particularly, the present invention can provide a system, method, and framework for predicting an “expectation” or “goal” (e.g., an expected state or goal state) for the effect of the collaborative or transformational activities.

Another exemplary feature of the present invention can provide a system, method, and framework for measuring the impact of a set of transformational activities based on social networks and attributes observed before and after a collaborative activity, as well as the “expected” or “goal” state.

The present invention extends the use of social network analysis (SNA). For example, the present invention can provide before and after state comparison. The present invention also can provide transformational guidance and course correction, based on, for example, such before and after state comparison.

One exemplary aspect of the invention provides a system and method for measuring the impact of a set of collaborative activities, such as business transformational activities, based on “Hamming”—like distances between social networks and attributes observed (e.g., based on path density) before and after the set of collaborative activities (e.g., business transformational activities).

In another exemplary aspect, the present invention can be used when collaborative activities are stepped or staged, and can include means for course correction.

The ordinarily skilled artisan would recognize and understand that the present invention is not limited to a set of collaborative activities, but can include a single collaborative activity, a plurality of collaborative activities, or sets thereof.

The ordinarily skilled artisan also would recognize and understand that the present invention is not limited to any particular collaborative activity or activities, but can include business transformational activities, or other transformational activities. For example, the present invention can be provided for measuring the impact of policy changes, changes in communication patterns, etc.

As an example, an exemplary aspect of the present invention can measure the impact of a policy on deterring terrorism, such as the impact of a policy for tracking money, a wiretapping policy, etc.

As another example, an exemplary aspect of the present invention can measure the impact of a change in communication patterns between people, companies, organizations, agencies, departments, etc.

The exemplary aspects of the present invention have an important advantage of providing a means for monitoring and/or quantifying a value of a particular transformational activity (or set of activities), for providing surveillance of the impact or effect of a particular transformational activity (or set of activities), for evaluating various aspects or effects of the transformational activity, etc.

An exemplary method 100 according to the present invention will be described with reference to FIG. 1.

The present invention can identify a transformational activity, such as a business transformational activity. The present invention can perform an analytical method of comparing before and after states of such a business transformational activity.

As illustrated in FIG. 1, an exemplary method 100 according to the present invention includes comparing social networks and attributes observed before and after at least one collaborative activity to measure an impact of the at least one collaborative activity (e.g., see 110).

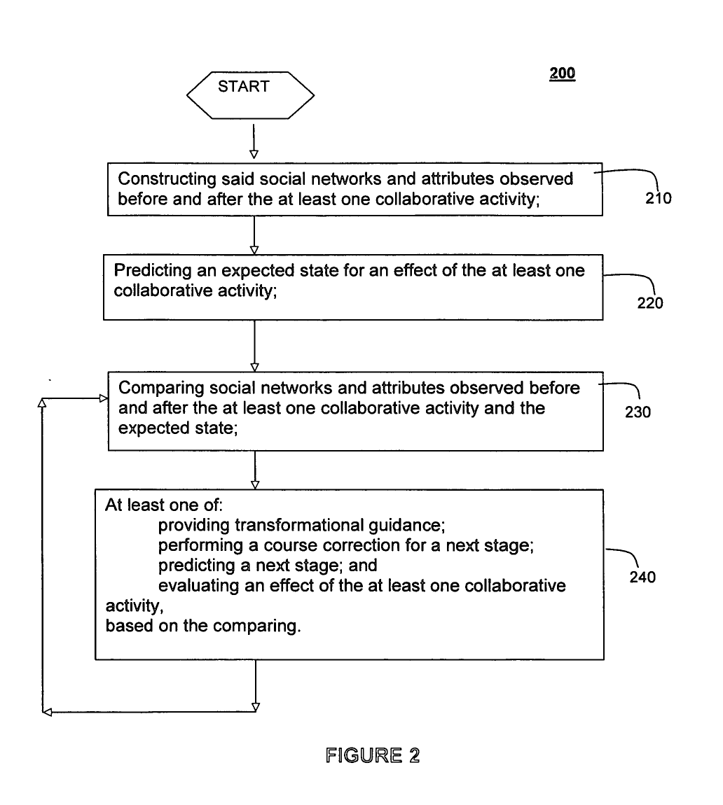

As illustrated in FIG. 2, an exemplary method 200 according to the present invention includes constructing social networks and attributes observed before and after the at least one collaborative activity (e.g., 210), predicting an expected state for an effect of the at least one collaborative activity (e.g., 220), comparing social networks and attributes observed before and after the at least one collaborative activity and the expected state (e.g., 230), and at least one of providing transformational guidance, performing a course correction for a next stage, predicting a next stage, and evaluating an effect of the at least one collaborative activity, based on the comparing (e.g., 240).

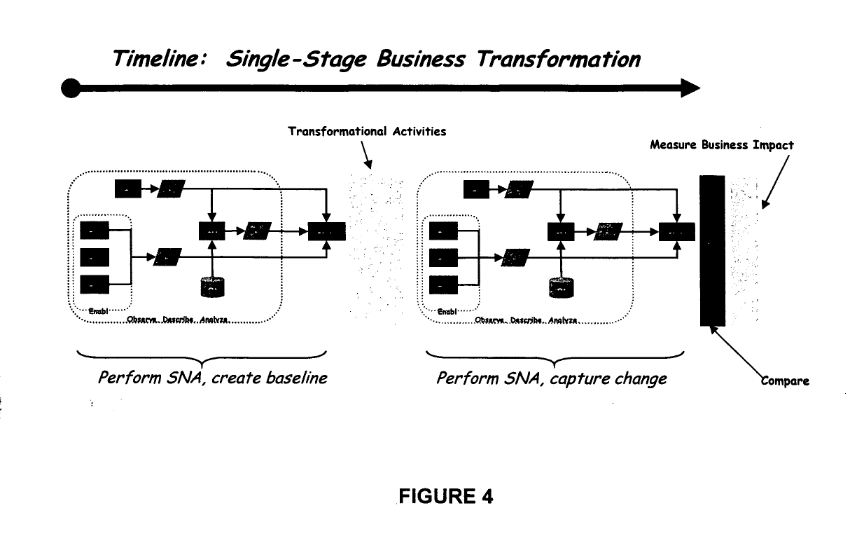

An exemplary system according to the present invention is derived with reference to FIG. 4.

As illustrated in FIG. 4, an exemplary system of the present invention can construct a social network from multiple, disparate, heterogeneous data sources. The exemplary system can include a social network analysis unit 440, which receives input from a plurality of disparate, heterogeneous data sources (e.g., 425, 430, and 445). The exemplary system can provide automated collection (e.g., scrapping, parsing, etc.) combined with traditional survey methods for social network construction.

For example, with reference again to FIG. 4, data 430 can be derived (or automatically collected) from social computing units 405, 410, and 415). The social computing units 405, 410, and 415, can include, for example, email, instant messaging, blogs, wikis, auctions, web interactive communication or research, online social networking websites, etc.

On the other hand, data 425 can be derived from traditional surveys 420 (e.g., one or more “user-generated” data sources).

Hence, the exemplary system according to the present invention can provide rich of data for populating a social network.

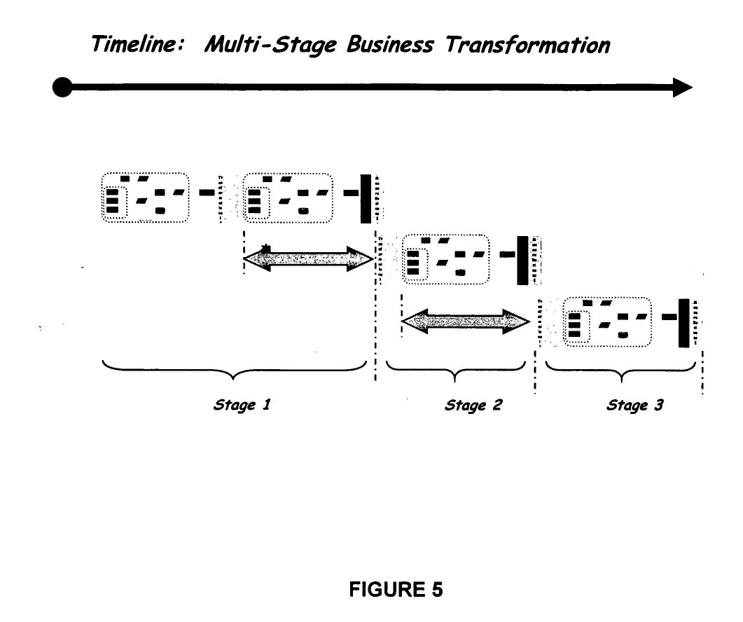

With reference to FIG. 5, an exemplary system according to the present invention is described with respect to a single stage collaborative activity (e.g., a single stage business transformation).

As illustrated in FIG. 5, an exemplary system of the present invention can include a first state unit (e.g., a “before” state unit) which performs social network analysis to create a baseline prior to a predetermined transformational activity (or activities). A second state unit (e.g., an “after” or “as-is” state unit) can perform social network analysis to capture a change in the state subsequent to the predetermined transformational activity (or activities).

For example, an exemplary feature of the present invention can analyze data of a social network (or construct a social network from, for example, a plurality of disparate, heterogeneous data sources) to derive state data for a “before” state (i.e., prior to the collaborative or transformational activity). That is, the exemplary aspects of the present invention can perform social network analytics to derive state data for a “before” state.

The exemplary aspects of the present invention also can analyze data of a social network (or construct a social network from, for example, a plurality of disparate, heterogeneous data sources) to derive state data for an “after” state or an “as is” state (i.e., subsequent to the collaborative or transformational activity). That is, the exemplary aspects of the present invention can perform social network analytics to derive state data for an “after” state.

With reference again to FIG. 5, the exemplary system according to the present invention can include a comparison unit for comparing the “before” state and the “after” state.

That is, the exemplary aspects of the present invention can compare the social network analysis before the business transformational activity with the social network analysis after the business transformational activity. In other words, the present invention can perform a before-and-after state comparison between the before state and the after state (e.g., “as is” state).

The ordinarily skilled artisan would recognize and understand that such a comparison can be made, for example, between before-and-after states derived from substantially the same metric sets.

According to the exemplary aspects of the present invention, the state comparison can be used to measure the business impact of the collaborative or transformational activities, as exemplarily illustrated in FIG. 5.

According to the exemplary aspects of the present invention, the state comparison can be used to perform, for example, a course correction for a next stage, to predict a next stage, to evaluate the effect of the activity, etc.

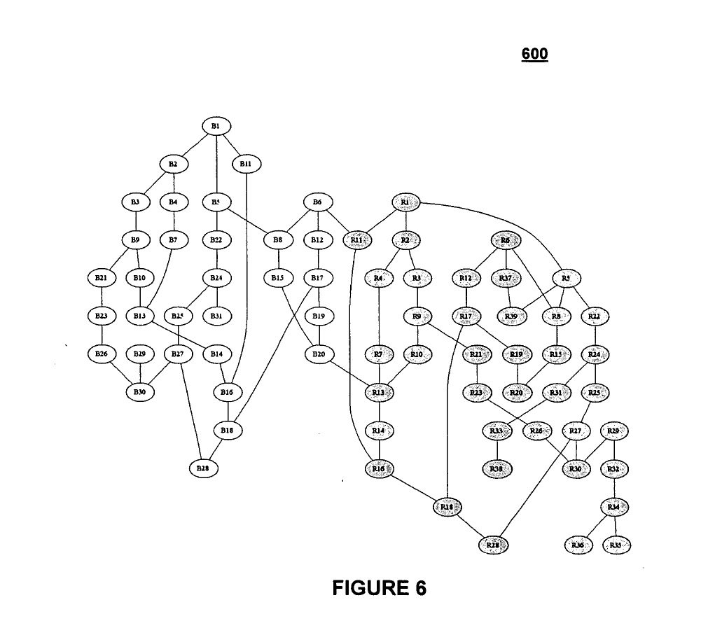

With reference to FIG. 6, an exemplary system according to the present invention is described with respect to a multi-stage collaborative activity (e.g., a multi-stage business transformation).

As illustrated in FIG. 6, an exemplary system of the present invention can include, for example, three stages. In the first stage, the social network analysis can be performed before and after a one or more collaborative (e.g., business transformational) activities, and the before and after stages can be compared to measure the impact (e.g., the business impact) of the collaborative (or business transformational) activities, for example, as similar described above with reference to the exemplary system of FIG. 5.

As illustrated in FIG. 6, the exemplary system can use the business impact analysis to determine a course correction (e.g., the second collaborative or transformational activity) of the next stage (e.g., stage 2) of the business transformation.

According to the exemplary aspects of the present invention, the process can be repeated for the second stage.

For example, in the second stage, the social network analysis can be performed after the transformation activity based on the course correction from stage 1, and can be compared with the preceding social network analysis (or, for example, an average of one or more of prior social network analysis) to measure the impact (e.g., the business impact) of the collaborative (or business transformational) activity.

According to the exemplary aspects of the present invention, the process can be repeated for the third stage, and so on. For example, the present invention can be implemented over a predetermined or finite period of time (e.g., a development process) or continuously.

According to the exemplary aspects of the present invention, analytics (e.g., derived from the “as is” state and described via a social network) can be used to determine, for example, course correction.

Also, according to the exemplary aspects of the present invention, with the “before” social network analysis, the present invention not only establishes a benchmark (e.g., for comparing the “after transformational state” to), but also provides means for setting (or calculating, determining, etc.) a goal or expectations for the effect of the business transformation.

According to the exemplary aspects of the invention, the goal or expectations can be described in terms of social networking, and can be used as a source of comparison as well. For example, after the transformation, the new state (e.g., as defined by the social network) can be compared with both the “before” state (e.g., to see how much has changed) as well as to an “expected” or “goal” state, to evaluate the transform activity.

The ordinarily skilled artisan would recognize and understand that the present invention can perform, for example, course correction at each stage of a multistage business transformational activity. However, it is not necessary that each stage include course correction derived from the previous activity. That is, the present invention can include other collaborative or transformational activities which are not derived from the previous activity.

That is, according to the exemplary aspects of the present invention, the comparison can be used to guide a next stage of a process (e.g., a development or implementation process).

As mentioned above, the present invention can provide an important advantage of determining or quantifying value creation in a collaborative activity (e.g., a business transformational activity). The measured impact of such collaborative activities can be used, for example, to provide information on, or to articulate, the business value to a client of a particular service or product being offered. The present invention can provide a mechanism for monitoring and tracking the benefit and value along the way (e.g., in a multi-stage business transformation), as well as for predicting the value along the way, performing course correction based on the before and after states and/or the predicted outcome.

The present invention has recognized that changing business processes can involve people or changing communication patterns among the people performing the work. Several examples are provided below with reference to FIGS. 6-8.

With reference to FIG. 6, the exemplary aspects of the present invention can observe new connections and communication patterns, and use such observations to identify/attribute new projects, innovations and collaborations, on a “business event” (e.g., an interdepartmental mixer).

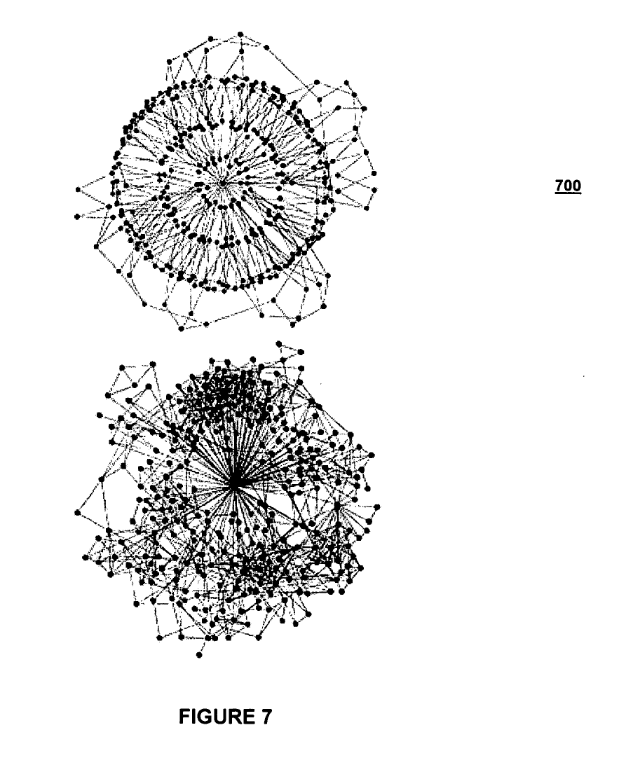

With reference to FIG. 7, the exemplary aspects of the present invention can measure the impact of a wiretapping policy on the communication patterns of terrorists.

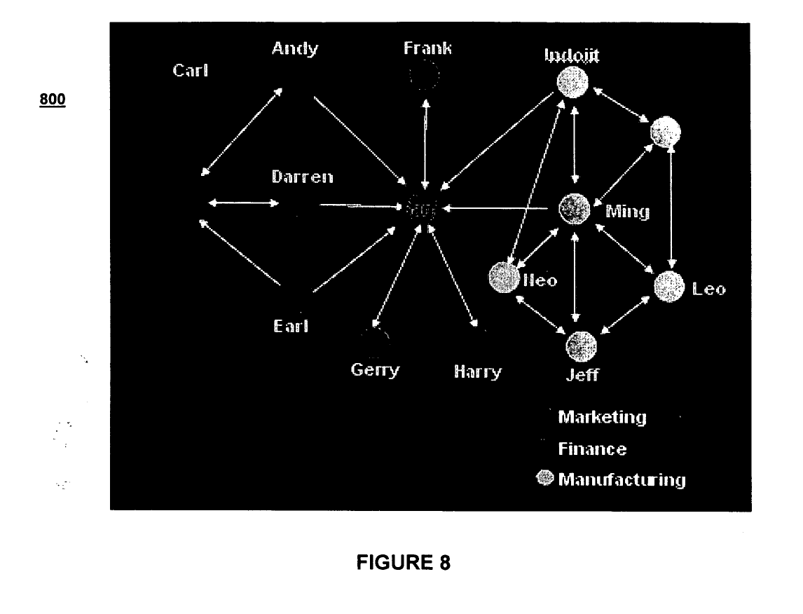

With reference to FIG. 8, the exemplary aspects of the present invention can assess risk reduction when a new enterprise financial system is introduced, based on changes in processes of information sharing.

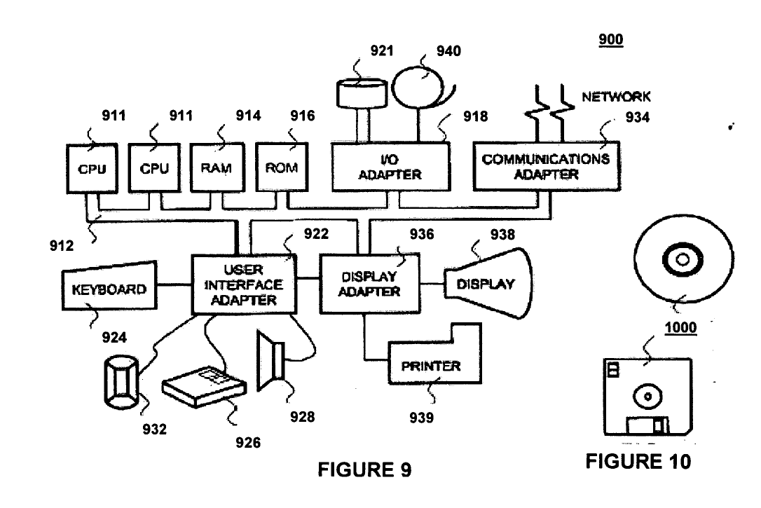

FIG. 9 illustrates an exemplary hardware/information handling system 900 for incorporating the present invention therein, and FIG. 10 illustrates a signal bearing medium 1000 (e.g., storage medium) for storing steps of a program of a method according to the present invention.

FIG. 9 illustrates a typical hardware configuration of an information handling/computer system for use with the invention and which preferably has at least one processor or central processing unit (CPU) 911.

The CPUs 911 are interconnected via a system bus 912 to a random access memory (RAM) 914, read-only memory (ROM) 916, input/output (I/O) adapter 918 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, an Intranet, a personal area network (PAN), etc., and a display adapter 936 for connecting the bus 912 to a display device 938 and/or printer 939.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 911, as represented by the fast-access storage for example. Alternatively, the instructions may be contained in another signal-bearing media, such as a data storage disk/diskette 1000 (FIG. 10), directly or indirectly accessible by the CPU 911.

Whether contained in the disk/diskette 1000, the computer/CPU 911, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

While the invention has been described in terms of several exemplary aspects, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A computer implemented method of measuring an impact of at least one collaborative activity, the method comprising:
comparing social networks and attributes observed before and after said at least one collaborative activity.

2. The method according to claim 1, further comprising:
constructing said social networks and attributes observed before and after said at least one collaborative activity.

3. The method according to claim 2, wherein constructing comprises:
constructing each of said social networks from a plurality of disparate, heterogeneous data sources.

4. The method according to claim 1, further comprising:
predicting an expected state for an effect of said at least one collaborative activity.

5. The method according to claim 4, wherein said comparing comprises:
comparing social networks and attributes observed before and after said at least one collaborative activity and said expected state.

6. The method according to claim 1, further comprising:
providing at least one of transformational guidance and course correction based on said comparing.

7. The method according to claim 1, further comprising at least one of:
performing a course correction for a next stage, predicting a next stage, and evaluating an effect of said at least one collaborative activity.

8. The method according to claim 1, wherein said comparing is based on “Hamming”—like distances between said social networks and attributes observed (e.g., based on path density) before and after said at least one collaborative activity.

9. The method according to claim 1, wherein said comparing is based on path density between said social networks and attributes observed before and after said at least one collaborative activity.

10. The method according to claim 1, wherein each of said social networks and attributes observed before and after said at least one collaborative activity are derived from a substantially same metric set.

11. The method according to claim 1, further comprising:
at least one of monitoring and quantifying a value of said at least one collaborative activity.

12. The method according to claim 1, further comprising:
comparing social networks and attributes observed before and after a second collaborative activity,
wherein said second collaborative activity occurs at a time after said first collaborative activity.

13. A system for measuring an impact of at least one collaborative activity, the system comprising:
a comparing unit that compares social networks and attributes observed before and after said at least one collaborative activity.

14. The system according to claim 13, further comprising:
a social network constructing unit that constructs each of said social networks from a plurality of disparate, heterogeneous data sources.

15. The system according to claim 13, further comprising:
a predicting unit that predicts an expected state for an effect of said at least one collaborative activity.

16. A system for measuring an impact of at least one collaborative activity, the system comprising:
means for constructing social networks and attributes observed before and after said at least one collaborative activity; and
means for comparing social networks and attributes observed before and after said at least one collaborative activity.

17. The system according to claim 16, further comprising:
means for predicting an expected state for an effect of said at least one collaborative activity, wherein said means for comparing compares said social networks and attributes observed before and after said at least one collaborative activity and said expected state; and
means for providing at least one of transformational guidance and course correction based on said comparing.

18. The system according to claim 16, further comprising:
means for at least one of performing a course correction for a next stage, predicting a next stage, and evaluating an effect of said at least one collaborative activity.

19. A method of deploying computing infrastructure in which recordable, computer-readable code is integrated into a computing system, and combines with said computing system to perform the method according to claim 1.

20. A signal-bearing medium tangibly embodying a program of recordable, machine-readable instructions executable by a digital processing apparatus to perform the method according to claim 1.
